(19) United States
(12) Patent Application Publication
(10) Pub. No.: US 2007/0175097 A1
(43) Pub. Date: Aug. 2, 2007

(54) Pet door with built in alarm

(76) Inventors: David Thorne, Valencia, CA (US); Ashley G. Howden, Valencia, CA (US)

Correspondence Address: LAW OFFICES OF DAVID L. HOFFMAN, 27023 MCBEAN PKWY, SUITE 422, VALENCIA, CA, 91355, US

(21) Appl. No.: 11/582,149

(22) Filed: Oct. 17, 2006

Related U.S. Application Data
(60) Provisional application No. 60/727,704, filed on Oct. 17, 2005.

(51) Int. Cl. E05D 15/48

(52) U.S. Cl. 49/169

(57) ABSTRACT

A pet door assembly has a frame having an opening defined therein, a flap mounted to the frame for covering the opening and movable to allow a pet to pass therethrough, a cover removably mounted to the frame to cover the opening and prevent passage through the opening, a detector mounted to the frame for detecting when the cover has been removed, and an alarm sound generator mounted to the frame for generating a sound in response to the detector detecting removal of the cover. In another embodiment, there is a cover for a pet door having an alarm which cover may be retrofit onto a pet door assembly of a type having a frame with an opening defined therein, and a flap for covering the opening. The cover is sized to replace an existing cover for the door, and has an alarm assembly mounted on it. The alarm assembly has a detector for detecting when the cover has been removed, and an alarm sound generator for generating a sound in response to the detector detecting removal of the cover. There is also a detector element mountable on the frame for being placed in the proximity of the detector when the cover is mounted on the frame.

### CROSS REFERENCE TO RELATED APPLICATION(S)

This application claims priority from U.S. Provisional Patent Application Ser. No. 60/727,704 filed Oct. 17, 2005, and which is incorporated by reference herein.

### BACKGROUND OF THE INVENTION

1. Field of the Invention

The present invention relates to pet doors, and more specifically, a pet door with a security alarm, and to an alarm built into a slide for a pet door.

2. Description of the Related Art

Pet doors are a great way to allow pets unfettered ingress and egress from a house or structure so that a pet owner does not need to continually open and close a door to let a pet out or in. One drawback, especially as pet doors get larger, is a concern over security against intruders. Another concern is to keep track of when the door is being used.

It has been proposed to build a pet door with an alarm for intruders. One such pet door with an alarm is disclosed in U.S. Pat. No. 4,347,502 to Holmes et al. The door has a frame with a passageway therethrough, and a swingable flap in the door. In addition to the flap, the door has an interior cover member and an exterior cover member removably secured to the inside and outside of the frame, respectively. A switch such as a leaf spring biased limit switch is mounted between the swingable flap and the interior cover member, and also there is a sound signal box activated by a trip switch. The limit switch is mounted on the frame and against the inner portion of the exterior door, so that when the exterior door is removed, the limit switch is triggered. There is an electrical connection from the leaf switch to the sound signal box, which triggers the alarm in response to triggering of the leaf switch. This structure is cumbersome in that it requires two cover members for the door, mounting the alarm components in multiple places on the door, and running an electrical connection from the leaf switch to the sound signal box. Moreover, it is not readily capable of universal or retrofit use. Further, the leaf switch mounted on the frame may readily succumb to the elements and is subject to wear and tear from the pet's use of the door. Potentially it is a hazard for the pet.

What is needed is a simple and reliable alarm structure, and one that is also capable of simple retrofit and universal applications.

### SUMMARY OF THE INVENTION

In one embodiment, a pet door incorporates an alarm within its inside frame. This alarm is triggered when the inside slidable cover is removed in an unauthorized manner. In another embodiment, there is an alarm incorporated into and mounted on a slidable cover, which slidable cover may be made in multiple shapes and sizes, and may be used to retrofit any pet door that accepts a slidable cover.

The door solves several security problems. The first is an intruder forcing in the security slide and reaching through the pet door to open the house door and gaining entry. This alarm also acts as a warning to a parent if a child tries to remove the slide to go outside the house, thus helping to keep track of the child and helping to minimize danger.

### BRIEF DESCRIPTION OF THE DRAWINGS

FIG. 1 is top perspective view of a portion of a pet door with a slidable panel removed and in accordance with one embodiment of the invention;

FIG. 2 is a partial schematic view of an inside of a front “clam-shell” half of the pet door of FIG. 1;

FIG. 3 is a rear view of a top portion of the slidable panel for the pet door of FIG. 1;

FIG. 4 is a front perspective view of a portion of the top portion of the front “clam-shell” half of the door of FIG. 1 to show inner components of the pet door of FIG. 1;

FIG. 5 is a schematic view of a circuit providing an alarm for the pet door of FIG. 1;

FIG. 6 is a front perspective view of a pet door of a type to which the invention may be applied, showing a slidable panel in place in the door;

FIG. 7 is a cross sectional view of the portion of FIG. 6 taken along a line 7-7;

FIG. 8 is an inside view of a rear “clam-shell” half of the door of FIG. 1;

FIG. 9 is a front partial schematic view of a top front portion of a slidable panel of a type usable in a pet door of the type of FIGS. 1 and 6 with an alarm in accordance with a second embodiment of the invention;

FIG. 10 is an enlarged partial schematic view of the front portion of the frame of FIG. 8;

FIG. 11 is a cross sectional view of the portion of FIG. 10 taken along a line 10-10; and

FIG. 12 is a view of a group of multiple size panels for fitting various pet doors.

### DESCRIPTION OF THE PREFERRED EMBODIMENT(S)

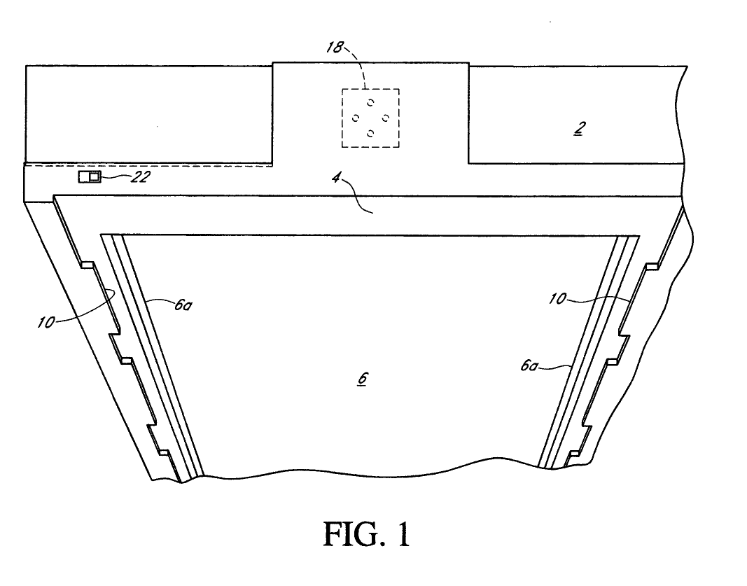

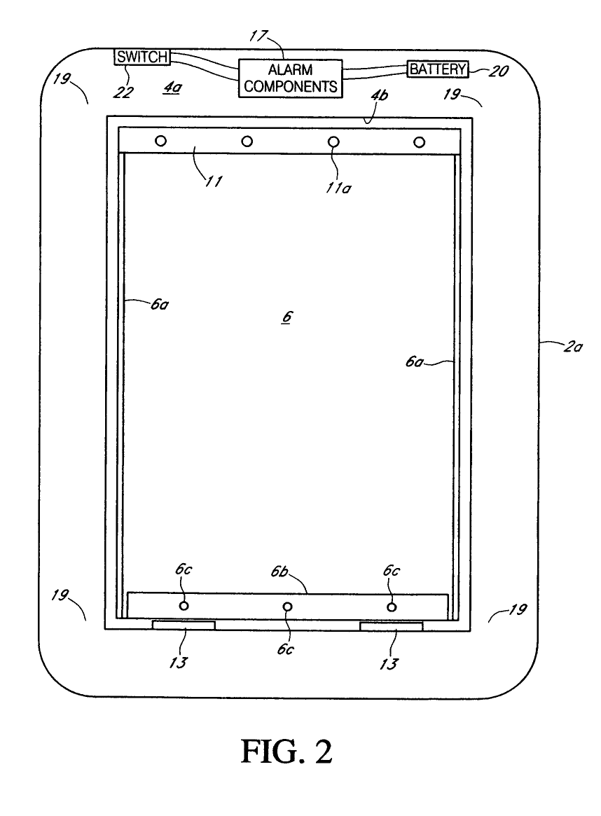

With reference to FIGS. 1 to 6, A pet door 2 has a frame 4 which is generally rectangular and a plastic or flexible flap 6 hinged to the frame near or at the top of the frame. As a pet moves in and out, the door flap moves up and when the pet passes, the flap falls back into place.

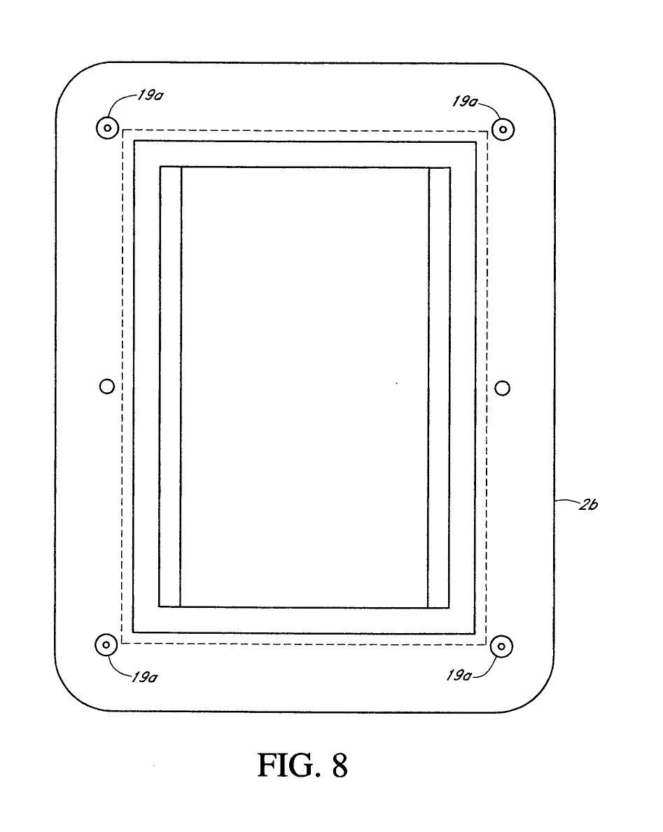

Flap 6 may have weather stripping 6a at its sides and may be fixed by screws 11a or the like to a panel 11 depending down from a first or front clam-shell half 2a of frame 4. At the bottom of flap 6, there may be a metal piece 6b fastened by screws of bolts 6c to the flap. The metal, preferably stainless steel, provides weight to the flap and more importantly helps register the flap in the opening by attraction to magnets 13 disposed in the frame. The other clam-shell half 2b of the frame is shown in FIG. 8. Holes 19 and posts 19a register and provide a place for screws or bolts to fix the clam-shell halves 2a, 2b together to form the frame 4, which may be clam-shelled with the half 2b located outside a wall or door, and half 2a located inside a wall or door.

So that the pet owner can block access through the door, there is also a slidable panel 8 that may be placed in grooves or slots 10 formed on the frame (i.e., the portion disposed inside the house or structure). The panel 8 is slid out by the owner to provide access through the door 2. At times when the owner wants security, e.g., night-time, or at other times when the owner desires to keep the animals in or out, slidable panel 8 is disposed in grooves 10. In some embodiments, panel 8 may be locked in place.

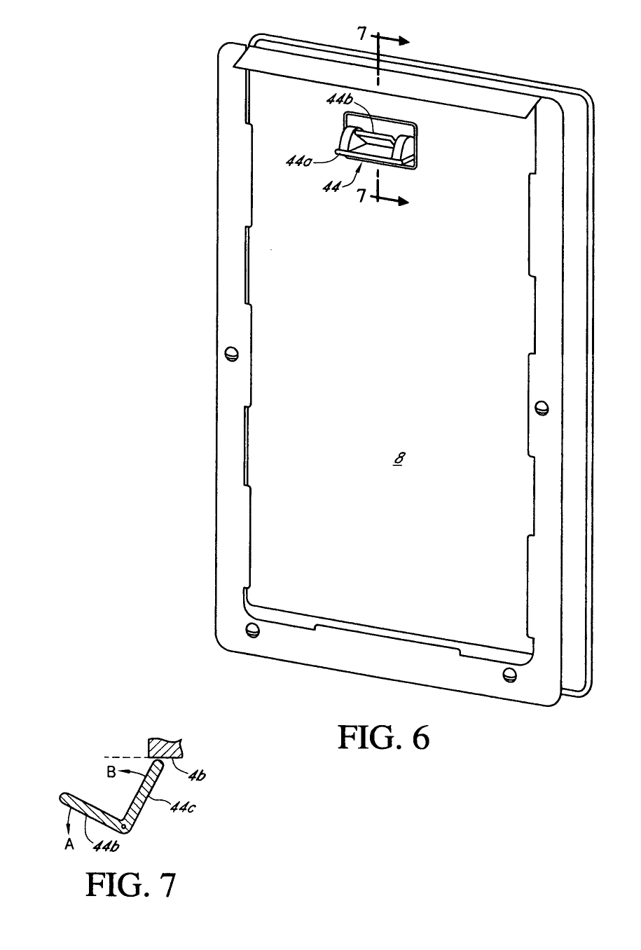

As shown in FIG. 6, panel 8 is slid into place. There may be a lock system which sets when the panel is moved into place. The lock system in a preferred embodiment, is shown in FIGS. 6 and 7. A handle mechanism 44 has a first member 44a and a second member 44b. The second member 44b is pivotably mounted and has an extension tab 44c and spring biased into the position of FIG. 7, so that the panel locks into the frame when the panel is slid fully down into grooves 10. To release, when second member 44b is squeezed toward the first member 44a (in the direction of arrow A), extension tab 44c rotates (in the direction of arrow B) to remove it from interfering with underside 4b of the top of frame 4. Any suitable locking system may be used with the invention and any suitable frame having a slidable or movable, or otherwise removable panel for closing the pet door may be used.

An alarm is fitted into the housing. The alarm has alarm components 17, an on/off switch 22, and a battery 20. One of the alarm components is an annunciator 18 to sound an alarm. Another is a proximity sensor, preferably a reed switch 16.

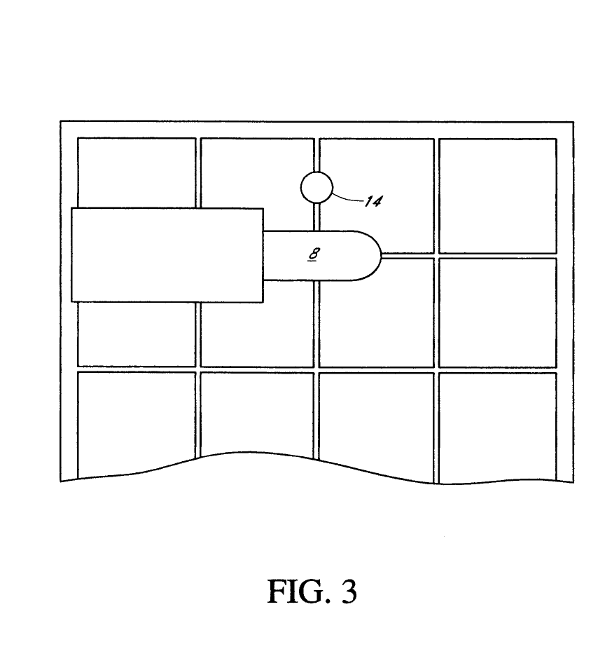

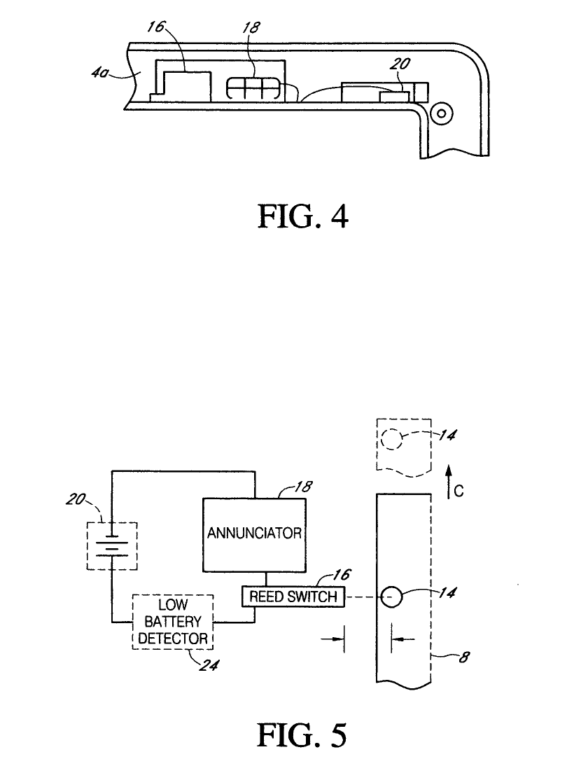

As shown in FIG. 3, there is a magnet 14, preferably at or near top center of the slidable panel 8, proximate and essentially opposite where reed switch 16 is located in the alarm components 17 (see also FIG. 4). As is typical in alarm systems, reed switch 16 normally remains open as long as the magnet 14 is within a desired proximity, which may be preset. Magnet 14 preferably is exposed on the inside of panel 8.

As shown best in the schematic view of FIG. 5, when panel 8 is in grooves 10, magnet 14 is proximate reed switch 16. Reed switch 16 is preferably located in the frame at the inside top 4a so that the positions of the reed switch and magnet 14 are within the desired proximity. When slidable panel 8 is moved upward in the direction of arrow C (or otherwise moved) so that magnet 14 and reed switch 16 are separated by more than the desired, preset proximity, reed switch 16 closes and alarm annuciator 18 sounds.

Annunciator 18 may be powered by a battery 20, preferably a readily available size, e.g., AAA, AA, or 9 Volt battery. It may also be like a watch battery, if a smaller size is desired. Preferably, the alarm is a loud chirping and/or continuous sound although it can also be otherwise, and may be provided by a piezoelectric material. Preferably, on/off switch 22 is also on the top 4a of the frame. The switch will be set by the pet owner to “on” when the slidable panel is in the closed position (and the owner wants security) and set to “off” when the slidable panel is out and the door is in use.

A low battery detector 24 should also preferably be in the circuit, like a smoke detector has.

The amount of movement for the magnet to be beyond the preset range and activate the reed switch may be any desired amount, but is preferably small, e.g., one quarter of an inch. Therefore, if someone outside kicks out the slidable panel or if a child moves the slidable panel even a small amount, the alarm will sound.

In accordance with a second preferred embodiment of the invention, a slidable panel of the type used in a pet door has an alarm assembly mounted thereon. In a preferred version of this second embodiment, the slidable panel is sized to replace an existing slidable panel on a pet door assembly, and thus the panel may be made to fit on any pet door of the slidable panel type. Therefore, any such pet door may be readily retrofit with the panel having the alarm.

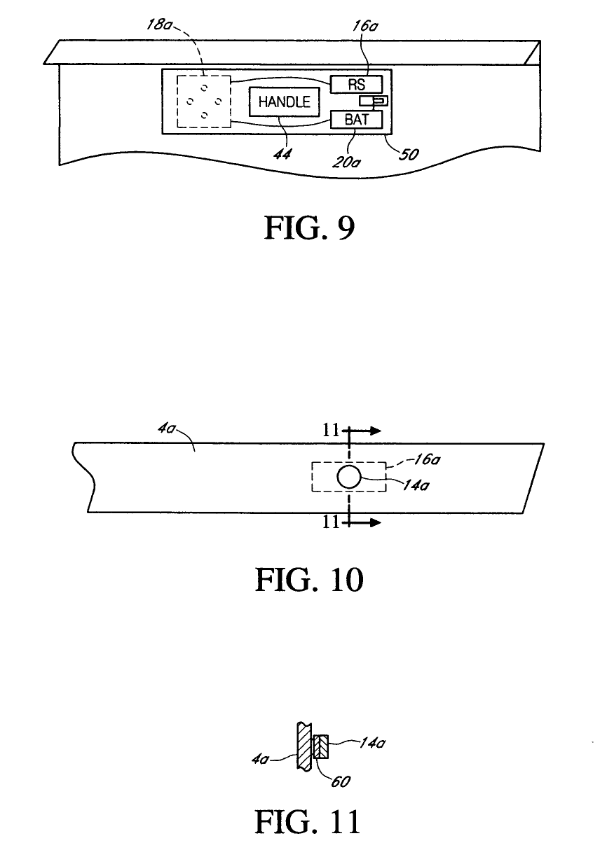

FIGS. 9 to 12 show this second embodiment. The pet door may be of the same type as shown in FIG. 1, but without an alarm. The slidable panel 8a of the second embodiment may be the same as slidable panel 8, except that it does not have magnet 14 thereon. Instead, there is a housing 50 attached to the outside of the slide member 8a. For example, the housing 50 may be made to surround handle 44, which may be the same as in the first embodiment.

Inside housing 50 there is a battery 20a, a reed switch 16a, and an annunciator 18a, all electrically connected. Battery 20a, reed switch 16a and annunciator 18a may be the same as described above in the first embodiment. In addition, a low battery indicator may also be used.

A battery 14a may be mounted on the front facing interior panel of the top 4a of the frame, in a position which is essentially opposite and proximate where reed switch 16a will be located when panel 8a is slid into the frame. Magnet 14a may be mounted using, e.g., double sided tape 60 or epoxy, or could also have a screw hole and be screwed to the frame. Other mechanisms to attach the magnet 14a may be used.

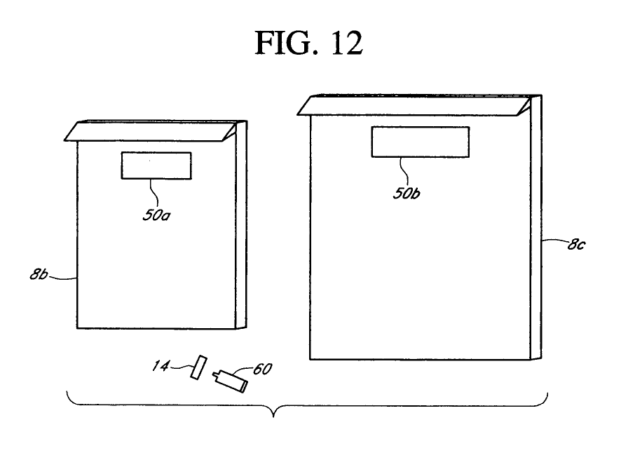

The alarm works the same as in the first embodiment. However, in this embodiment, the alarm can be retrofit on any existing pet door frame that uses a slidable panel or other movable panel. As shown in FIG. 12, the slide may be made in multiple sizes, such as slides 8b and 8c, with alarm housings 50a, 50b, respectively. The shape, thickness, height, width and other aspects of the slidable or movable cover may be varied to fit any existing pet door frame of this type, as shown in FIG. 12.

The slidable cover with the alarm may be sold as a kit, with the magnet 14 and double sided tape or a small container 60 of epoxy or other mechanism to attach the magnet to the pet door frame.

The invention may also be embodied as a method of making a slidable cover with the alarm components housed on the slidable cover and sized for fitting an existing pet door is already installed and which already has a slidable cover, replacing the existing slidable cover with the slidable cover having the alarm components, and fixing a magnet to the existing pet door frame of the already installed pet door opposite where the detector is on the slidable cover when the slidable cover with alarm is slid into place in the existing pet door.

As is well known in the art, the reed switch is an electrical switch operated by an applied magnetic field. It typically consists of a pair of contacts on ferrous metal reeds in a hermetically sealed glass envelope. The contacts may be normally open, closing when a magnetic field is present, or normally closed and opening when a magnetic field is applied. Instead of a reed switch, another type of proximity sensor may be used, such as a pair of infrared alignment sensors. Advantages of a reed switch are that it is relatively inexpensive and it is passive.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

What is claimed is:

1. A pet door assembly, comprising:
i. a frame having an opening defined therein;
ii. a flap mounted to the frame for covering the opening and movable to allow a pet to pass therethrough;
iii. a cover removably mounted to the frame to cover the opening and prevent passage through the opening;
iv. a detector mounted to the frame, and means on the cover proximate the detector to which the detector is responsive, for detecting when the cover has been removed; and
v. an alarm sound generator mounted to the frame for generating a sound in response to the detector detecting removal of the cover.

2. A pet-door assembly as recited in claim 1, further comprising a power source for the alarm sound generator mounted on the frame.

3. A pet door assembly as recited in claim 1, wherein the detector comprises a reed switch.

4. A pet door assembly as recited in claim 1, wherein the power source comprises a battery and the pet door assembly further comprises a low battery indicator mounted on the frame.

5. A pet door assembly as recited in claim 1, wherein the power source and detector are mounted on the frame above the opening and the means to which the detector is responsive is a magnet disposed on the cover.

6. A cover with an alarm for a pet door assembly of a type having a frame with an opening defined therein, a flap for covering the opening, wherein the cover with the alarm comprises:
i. a cover member sized for covering the opening; and
ii. an alarm assembly mounted on the cover member comprising a detector for detecting when the cover member has been removed, and an alarm sound generator for generating a sound in response to the detector detecting removal of the cover member.

7. A cover as recited in claim 6, further comprising a power source for the alarm sound generator mounted on the cover.

8. A cover as recited in claim 6, further comprising a housing on the cover for containing the detector and the alarm sound generator.

9. A cover as recited in claim 6, further comprising a detector element mountable on the frame for being placed in the proximity of the detector when the cover member is on the frame.

10. A cover as recited in claim 6, wherein the cover member is substantially planar in shape.

11. A cover as recited in claim 6, wherein the cover member further comprises means for locking the cover member in place when used in a pet door.

12. An alarm retrofit kit for a pet door assembly of a type having a frame with an opening defined therein, a flap for covering the opening, and an existing cover member for closing the opening, wherein the alarm retrofit kit comprises:
i. a replacement cover member sized the same as the size of the existing cover member for covering the opening;
ii. an alarm assembly mounted on the replacement cover member comprising a detector for detecting when the replacement cover member has been removed from covering the opening, and an alarm sound generator for generating a sound in response to the detector detecting removal of the replacement cover member; and
iii. a detector element mountable on the frame of the existing pet door for being placed in the proximity of the detector when the replacement cover member is on the frame.

13. An alarm retrofit kit as recited in claim 12, further comprising a power source for the alarm sound generator.

14. An alarm retrofit kit as recited in claim 12, further comprising means for attaching the detector element to the frame.

15. An alarm retrofit kit as recited in claim 14, wherein the detector comprises a magnetic reed switch, and the detector element comprises a magnet.

16. An alarm retrofit kit as recited in claim 12, further comprising a switch for turning the alarm on and off mounted on the cover member.

17. A method of retrofitting an existing installed pet door assembly of a type having a frame with an opening defined therein, a flap for covering the opening, and an existing cover member for closing the opening, wherein the method comprises the steps of:
i. making a replacement cover with alarm components housed on the replacement cover, and the replacement cover sized the same as the existing cover member, so as to fit an existing installed pet door, wherein the alarm components comprise a detector for detecting when the replacement cover member has been removed from covering the opening, and an alarm sound generator for generating a sound in response to the detector detecting removal of the replacement cover member;
ii. replacing the existing cover member with the replacement cover member; and
iii. fixing a detector element to the existing pet door frame of the already installed pet door opposite where the detector is on the replacement cover member when the replacement cover member with alarm is put in place in the existing pet door.

18. A method as recited in claim 17, wherein in the step of fixing the detector element, one of double sided tape and epoxy is used.

19. A method as recited in claim 17, wherein the existing cover member is slidable into place in the existing pet door frame, and in the step of making, the replacement cover member is made so as to be slidable into the existing pet door frame.

20. A method as recited in claim 19, wherein the existing cover member has a locking mechanism and is lockable in place in the existing pet door frame, and in the step of making, the replacement cover member is made to have the same locking mechanism as the existing cover member so as to be lockable into the existing pet door frame.
